(19) United States
(12) Patent Application Publication
(10) Pub. No.: US 2012/0005115 A1
(43) Pub. Date: Jan. 5, 2012

(54) PROCESS RISK PRIORITIZATION APPLICATION

(75) Inventors: Mark G. Hofberg, Charlotte, NC (US); Daniel Bohen, Charlotte, NC (US)

(73) Assignee: BANK OF AMERICA CORPORATION, Charlotte, NC (US)

(21) Appl. No.: 12/827,193

(22) Filed: Jun. 30, 2010

(51) Int. Cl. G06Q 10/00

(52) U.S. Cl. 705/348

(57) ABSTRACT

Embodiments of the invention relate to systems, methods, and computer program products for prioritizing processes in terms of risk. Specifically, present embodiments provide assessment of process applicability to risk factors and an independent assessment of the relative importance of the risk factors. The two independent assessments, conducted by separate corporate entities, such as line-of-business and risk owners, are subsequently used to determine a process risk score that allows for the processes to be prioritized. The independent nature of the assessments provides for a highly objective, fact-based means of prioritizing processes based on risk.

### FIELD

In general, embodiments of the invention relate to methods, systems, apparatus and computer program products for process risk prioritization and, more particularly, for determining process risk prioritization by assessing, at a first entity level, the applicability of processes to risk prioritization factors; comparing, at a second entity level, the risk prioritization factors in terms of relative importance; determining a risk weighting based on the relative importance and determining a risk score and risk priority based on the applicability and the risk weighting.

### BACKGROUND

Risk is defined by the International Organization of Standardization in ISO 31000 as the effect of uncertainty on objectives (whether positive or negative). Risk management can therefore be considered the identification, assessment, and prioritization of risks followed by coordinated and economical application of resources to minimize, monitor, and control the probability and/or impact of unfortunate events or to maximize the realization of opportunities. Risks can come from uncertainty in financial markets, project failures, legal liabilities, credit risk, accidents, natural causes and disasters as well as deliberate attacks from an adversary. Several risk management standards have been developed including the Project Management Institute, the National Institute of Science and Technology, actuarial societies, and ISO standards. Methods, definitions and goals vary widely according to whether the risk management method is in the context of project management, security, engineering, industrial processes, financial portfolios, actuarial assessments, or public health and safety.

One aspect of risk management concerns prioritizing processes, including initiatives or projects, which an entity such as a corporation may implement, based on the level of risk associated with the process. Prioritizing processes in terms of risk becomes a daunting task because the prioritization will vary, in some instances, drastically, depending on whom is called on to make the assessment. One of the reasons for the subjectivity in terms of risk assessment and prioritization is that the corporate entities that perform such assessments tend to have competing interests.

Therefore, a need exists to develop an objective scheme for prioritizing processes based on risk. The desired risk assessment application should be founded on defensible, fact-based criteria and objective information so as to insure future control monitoring plan design and implementation. The desired process risk assessment and prioritization scheme should allow for more than one corporate level entity, such as line of business entities and risk owner entities, to provide inputs so as minimize the effect of divergent interests between the various corporate level entities. As a result the desired risk assessment and prioritization application should insure that process controls are commensurate, such that, an optimal balance is reached between process risk and process controls.

### SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention relate to systems, apparatus, methods, and computer program products for prioritizing processes in terms of risk. Specifically, present embodiments provide assessment of process applicability to risk factors and an independent assessment of the relative importance of the risk factors. Two or more independent assessments are subsequently used to determine a process risk score that allows for the processes to be prioritized. The independent nature of the assessments provides for a highly objective, fact-based means of prioritizing processes based on risk.

In specific embodiments of the invention, the process applicability to risk factor assessment is conducted by a line-of-business or business unit entity, while the relative importance of the risk factor assessment is conducted by a risk owner or risk management entity. Such independent assessments allows for the competing interests of the two entities to merge to create a risk-based process prioritization that results in optimization of controls relative to process risk.

An apparatus for prioritizing processes based on risk defines first embodiments of the invention. The apparatus includes a computing device including a memory and at least one processor. The apparatus further includes a process risk prioritization application stored in the memory and executable by the processor. The process risk prioritization application is configured to determine risk priority for a plurality of processes. The application includes a risk weighting routine configured to receive, from a second entity level entity, an importance indicator for each of a plurality of risk prioritization factors in comparison to each of the other risk prioritization factors and determine a risk weighting for each of the risk prioritization factors based on the importance indicators. Additionally, the application includes a risk score routine configured to receive, from a first entity level entity, an applicability score for each of a plurality of processes in relation to each of the risk prioritization factors and determine a risk score for each of the processes based on the applicability score and the risk weighting. Further the application includes a risk priority routine configured to determine a risk priority for each of the processes based on the risk scores.

In specific embodiments of the apparatus, the process-to-risk applicability input mechanism, which may be a spreadsheet-based grid, matrix or the like, is further configured to receive, from one or more line-of-business participants, the applicability scores for each of the plurality of processes in relation to each of a plurality of predetermined risk prioritization factors. In further specific embodiments of the invention, the risk-factor importance input mechanism, which may be a spreadsheet-based grid, matrix is further configured to receive, from one or more risk owner participants, the importance indicator for each of the risk prioritization factors in comparison to each of the other risk prioritization factors. In such embodiments, in the event that the applicability scores are received from two or more line-of-business participants or the importance indicators are received from two or more risk owner participants, the scores and/or importance indicators may be averaged to determine the mean value applicability scores and/or importance indicators. In addition, according to further specific embodiments, line-of-business participants and/or risk owner participants may be associated with a predetermined weighting factor, which takes into account the importance of the line-of-business and/or risk owner participants in the applicability score and/or importance indicator determination process, such that cumulative applicability scores and/or importance indicators are determined based on the applicability scores/importance indicators and the weighting factor of the participant.

In further specific embodiments of the apparatus, the risk weighting routine is further configured to implement Analytical Hierarchy Process (AHP) to determine the risk weightings.

In still further specific embodiments of the apparatus, the plurality of risk prioritization factors include two or more of technology risk, financial risk, regulatory risk, external risk, operational risk, strategy risk, associate risk and customer risk.

In yet other specific embodiments of the apparatus, the applicability score received by the process-to-risk applicability input mechanism is configured to be an integer value, such that zero represents no relation between the process and the risk prioritization factor and the configured highest value integer, “x” represents a strong relationship between the process and the risk prioritization.

Moreover, in other specific embodiments of the apparatus the importance indicator received by the risk factor importance input mechanism is configured to one of (1) much more important, (2) more important, (3) equally important, (4) less important or (5) much less important.

In additional specific embodiments of the apparatus, the risk score routine is further configured to determine a plurality of products by multiplying, for each risk prioritization factor, the applicability score by the risk weighting and summing the products to result in the risk score.

A method for prioritizing processes based on risk provides for second embodiments of the invention. The method includes receiving, from one or more first level entities, an applicability score for each of a plurality of predefined processes in relation to each of a plurality of predetermined risk prioritization factors. The method additionally includes receiving, from one or more second level entities, an importance indicator for each of the risk prioritization factors in comparison to each of the other risk prioritization factors. In addition, the method includes determining, via a computing device processor, a risk weighting for each of the risk prioritization factors based on the importance indicators. Moreover, the method includes determining, via a computing device processor, a risk score for each of the processes based on the applicability score and the risk weighting and determining a risk priority for the processes based on the risk scores.

In specific embodiments of the method, receiving the applicability score further includes receiving, from one or more line-of-business participants, the applicability score for each of the plurality of processes in relation to each of the plurality of predetermined risk prioritization factors. In further embodiments of the method, receiving the importance indicator further includes receiving, from a risk-owner entity, the importance indicator for each of the risk prioritization factors in comparison to each of the other prioritization factors.

In still further embodiments of the method, determining the risk weighting further comprises determining, via the computing device processor, the risk weighting by implementing Analytical Hierarchy Process (AHP).

In other specific embodiment of the method, receiving the applicability score further includes receiving the applicability score that is an integer value, such that zero represents no relation between the process and the risk prioritization factor and the highest value integer, “x” represents a strong relationship between the process and the risk prioritization. Moreover, in other specific embodiments of the method, receiving the importance indicator further includes receiving the importance indicator as one of (1) much more important, (2) more important, (3) equally important, (4) less important, or (5) much less important.

Moreover, in other specific embodiments of the method, receiving an applicability score further includes receiving the applicability score for each of the plurality of processes in relation to each of the plurality of risk prioritization factors, wherein the plurality of risk prioritization factors include two or more of technology risk, financial risk, regulatory risk, external risk, operational risk, strategy risk, associate risk and customer risk.

In still further specific embodiments of the method, determining the risk score further comprises multiplying, via a computing device processor, for each risk prioritization factor, the applicability score by the risk weighting to result in a product and summing, via the computing device processor, the products to result in the risk score.

A computer program product including a non-transitory computer-readable medium defines third embodiments of the invention. The computer-readable medium includes a first set of codes for causing a computer to receive a plurality of processes and an applicability score for each of the plurality of processes in relation to each of a plurality of predetermined risk prioritization factors. Additionally, the computer-readable medium includes a second set of codes for causing a computer to receive an importance indicator for each of the risk prioritization factors in comparison to each of the other risk prioritization factors. In addition, the computer-readable medium includes a third set of codes for causing a computer to determine a risk weighting for each of the risk prioritization factors based on the importance indicators. Moreover, the computer-readable medium includes a fourth set of codes for causing a computer to determine a risk score for each of the processes based on the applicability score and the risk weighting and a fifth set of codes for causing a computer to determine a risk priority for the processes based on the risk scores.

Thus, further details are provided below for systems, apparatus, methods and computer program products for prioritizing processes in terms of risk. Specifically, present embodiments provide for assessment of process applicability to risk factors and assessment of the relative importance of the risk factors, such that the assessments are conducted independently by separate corporate entities, for example, line-of-business entity and risk owner entity. The two independent assessments are subsequently used to determine a process risk score that allows for the processes to be prioritized. The independent nature of the assessments provides for a highly objective, fact-based means of prioritizing processes based on risk.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is schematic diagram of an apparatus configured to process prioritization based on risk, in accordance with embodiments of the present invention;

FIG. 2 is a schematic diagram of a more detailed apparatus configured to provide process prioritization based on risk, in accordance with embodiments of the present invention;

FIG. 3 is a schematic of a risk factor relative importance input mechanism prior to data entry, in accordance with embodiments of the present invention;

FIG. 4 is a schematic diagram of a risk factor relative importance input mechanism after entry of the importance indicators, in accordance with embodiments of the present invention;

FIG. 5 is a schematic diagram of a risk factor relative importance input mechanism after determination of the risk weighting, in accordance with embodiments of the present invention;

FIG. 6 is a schematic diagram of the process-to-risk applicability input mechanism prior to data entry, in accordance with embodiments of the present invention;

FIG. 7 is a schematic diagram of the process-to-risk applicability input mechanism after entry of the importance scores, in accordance with embodiments of the invention;

FIG. 8 is a schematic diagram of the process-to-risk applicability input mechanism after determination of the risk score, risk priority and risk category, in accordance with embodiments of the invention; and

FIG. 9 is a flow diagram of a method for process prioritization based on risk, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

As may be appreciated by one of skill in the art, the present invention may be embodied as a method, system, computer program product, or a combination of the foregoing. Accordingly, the present invention may take the form of an entirely software embodiment (including firmware, resident software, micro-code, etc.) or an embodiment combining software and hardware aspects that may generally be referred to herein as a “system.” Furthermore, embodiments of the present invention may take the form of a computer program product on a computer-readable medium having computer-usable program code embodied in the medium.

Any suitable computer-readable medium may be utilized. The computer-readable medium may be, for example but not limited to, an electronic, magnetic, optical, electromagnetic, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device; or transmission media such as those supporting the Internet or an intranet. Note that the computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described below with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

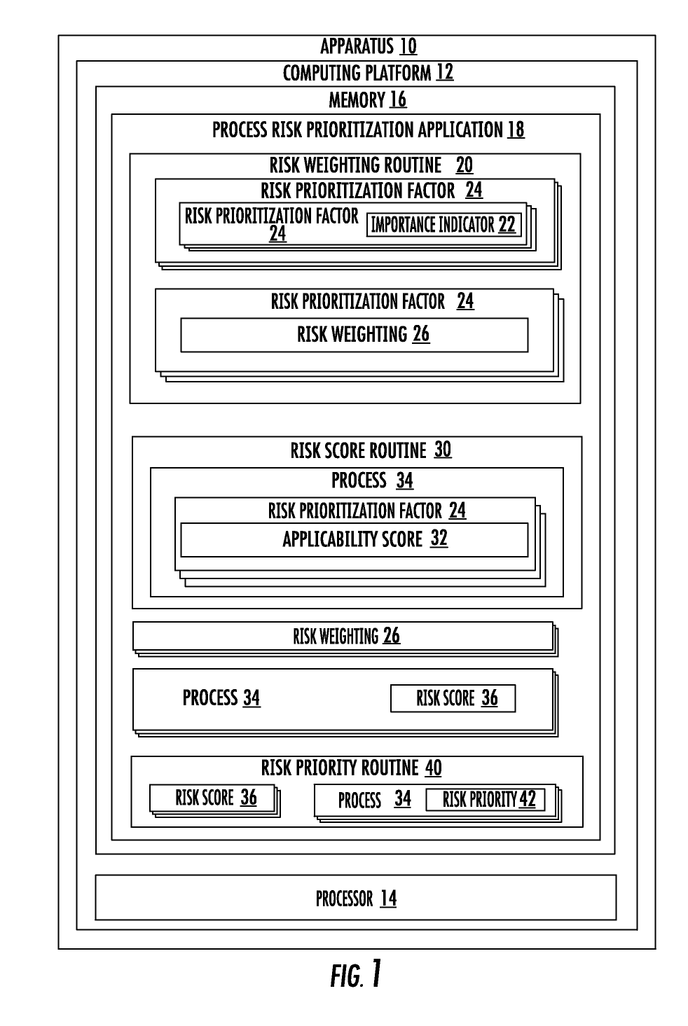

Thus, apparatus, systems, methods and computer program products are herein disclosed that provide. FIG. 1 provides a high level schematic diagram of an apparatus 10 configured for risk-based process prioritization, in accordance with embodiments of the present invention. The apparatus 10 includes a computing platform 12 having at least one processor 14 and a memory 16 in communication with the processor 14. The memory 16 stored process risk prioritization application 18, which is configured to determine risk priority for a plurality of processes. It should be noted that the term “process”, as herein described and claimed, includes sub-processes, initiatives, projects or the like.

The risk prioritization application 18 includes risk weighting routine 20 that is configured to receive a plurality of importance indicators 22 that indicate the relative importance between one of a plurality of risk prioritization factors 24 and another of the plurality of risk prioritization factors 24. The risk prioritization factors may be associated with the specific line-of-business, business unit or the like under which the specific processes that are being prioritized are included. Alternatively, risk prioritization factors may apply to all lines-of-business under consideration. In specific embodiments of the invention, in order to achieve independence in the risk-based process prioritization methodology, the importance indicators 22 are received from one or more second level entities within the business, such as a risk-owner/risk management participants or the like, while the applicability scores 32 (discussed infra.) are received from one or more first level entities within the business, such as a line-of-business participants, business unit participants or the like.

According to specific embodiments in the event that the applicability scores 32 are received from two or more line-of-business participants or the importance indicators 22 are received from two or more risk owner participants, the applicability scores 32 and/or importance indicators 22 may be averaged to determine a mean value applicability scores and/or importance indicators.

In addition, according to further specific embodiments, line-of-business participants and/or risk owner participants may be associated with a predetermined weighting factor, which takes into account the importance of the line-of-business and/or risk owner participants in the applicability score 32 and/or importance indicator 22 determination process, such that cumulative applicability scores 32 and/or importance indicators 22 are determined based on the applicability scores 32/importance indicators 22 and the weighting factor of the participant.

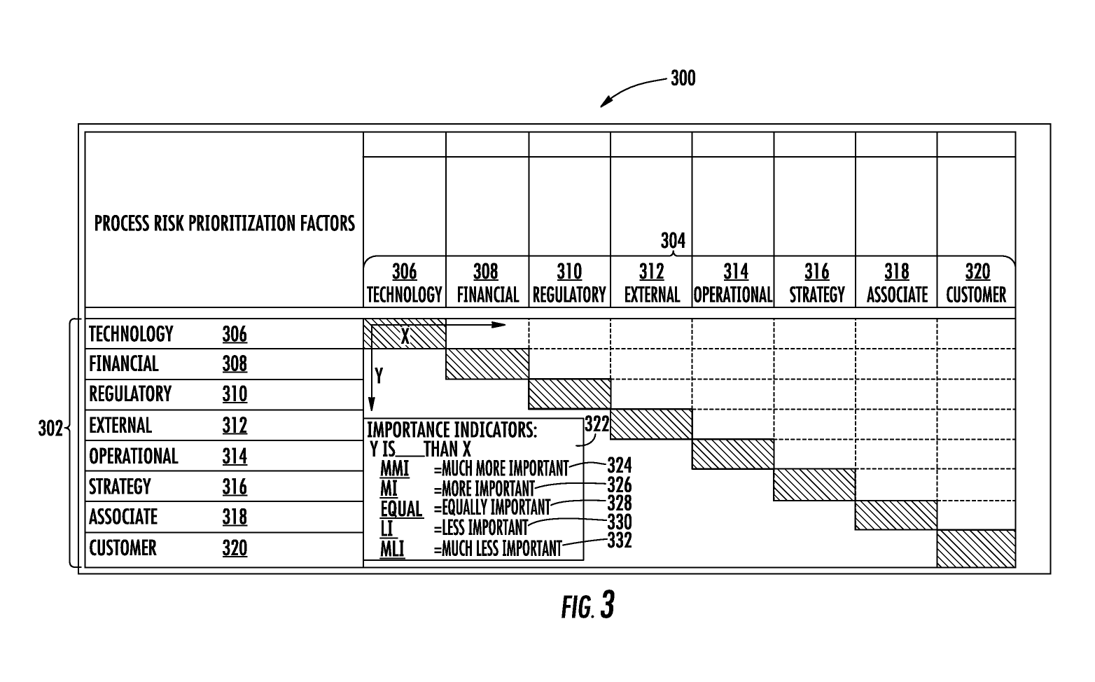

The risk weighting routine 20 is further configured to determine a risk weight 26 for each of the plurality of risk prioritization factors 24 based on the importance indicators 22. In specific embodiments of the invention the risk weighting routine is an Analytical Hierarchy Process (AHP) algorithm. AHP provides a comprehensive and rational framework for structuring a decision problem, for representing and quantifying its elements, for relating those elements to overall goals, and for evaluating alternative solutions. Further details related to importance indicator assessments and risk weighting determination are shown and described in relation to FIGS. 3-5, infra.

Process risk prioritization application 18 additionally includes risk score routine 30 that is configured to receive applicability scores 32 for each a plurality of processes 34 in relation to each of the plurality of risk prioritization factors 24. Thus, each applicability score indicates the strength of the relationship between a specific process and a specific risk prioritization factor. As previously noted, in specific embodiments of the invention, in order to achieve independence in the risk-based process prioritization methodology, the applicability scores 32 are received from one or more first level entities within the business, such as a line-of-business, business unit or the like, while the importance indicators 22, discussed previously, are received from one or more second level entities, such as a risk-owner/risk management entity or the like.

The risk score routine 30 is further configured to determine a risk score 36 for each of the processes based on the risk weighting 26 and applicability scores 32 for each risk prioritization factor 24. Since the importance indicators 22, which derive the risk weighting 26 and the applicability scores 32 are assigned by different entities within the business, such as the risk owner entity and the line-of-business entity, respectively, the resulting risk score 36 (and subsequent risk priority 42) are defensible, fact-based, objective parameters that can be used to prioritize process controls, plan design and implementation and the like.

In addition, process risk prioritization application 18 includes risk priority routine 40 that is configured to determine risk priority 42 for each of the plurality of predefined processes 34 based on the risk score 36. In this regard, the risk priority 42 provides for a numerical listing of the processes 34 in which the order of the listing coincides with the risk score 36; highest risk scores being determined to have highest priority listing and lowest risk scored being determined to have lowest priority listing.

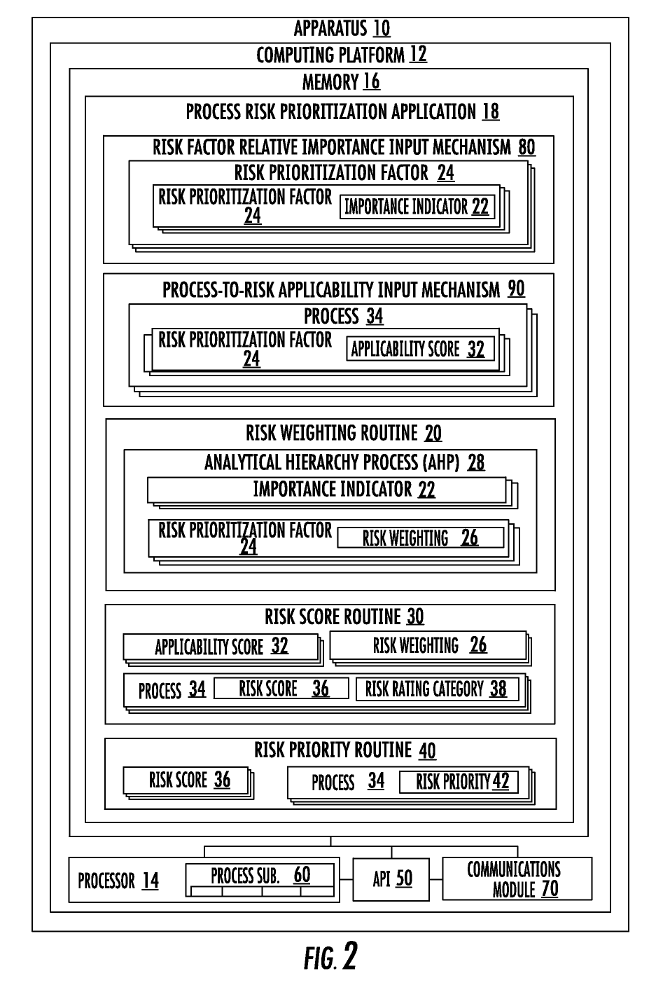

Referring to FIG. 2, shown is a more detailed block diagram of apparatus 10, according to embodiments of the present invention. The apparatus 10 is configured to provide. In addition to providing greater detail, FIG. 2 highlights various alternate embodiments of the invention. The apparatus 10 may include one or more of any type of computerized device. The present apparatus and methods can accordingly be performed on any form of one or more computing devices.

The apparatus 10 includes computing platform 12 that can receive and execute routines and applications. Computing platform 12 includes memory 16, which may comprise volatile and non-volatile memory, such as read-only and/or random-access memory (RAM and ROM), EPROM, EEPROM, flash cards, or any memory common to computer platforms. Further, memory 16 may include one or more flash memory cells, or may be any secondary or tertiary storage device, such as magnetic media, optical media, tape, or soft or hard disk.

Further, computing platform 12 also includes processor 14, which may be an application-specific integrated circuit (“ASIC”), or other chipset, processor, logic circuit, or other data processing device. Processor 14 or other processor such as ASIC may execute an application programming interface (“API”) 50 that interfaces with any resident programs, such as process risk prioritization application 18 and routines associated therewith or the like stored in the memory 16 of the apparatus 10.

Processor 14 includes various processing subsystems 60 embodied in hardware, firmware, software, and combinations thereof, that enable the functionality of apparatus 10 and the operability of the apparatus on a network. For example, processing subsystems 60 allow for initiating and maintaining communications and exchanging data with other networked devices. For the disclosed aspects, processing subsystems 60 of processor 14 may include any subsystem used in conjunction with process risk prioritization application 18 and related routines, sub-routines, sub-modules thereof.

Computer platform 12 additionally may include communications module 70 embodied in hardware, firmware, software, and combinations thereof, that enables communications among the various components of the apparatus 10, as well as between the other networked devices. Thus, communication module 70 may include the requisite hardware, firmware, software and/or combinations thereof for establishing a network communication connection and communicating risk scores 36, risk priority 42 or the like to business entities.

As previously noted, the memory 16 of apparatus 10 stores risk prioritization application 18, which is configured to determine risk priority for a plurality of processes

In specific embodiments of the invention, the risk prioritization application 18 includes risk factor relative importance input mechanism 80, which may be a spreadsheet-based grid, matrix or the like suitable for receiving importance indicators 22 that each indicate the relative importance between each of the plurality of risk prioritization factors 24 and a corresponding one of the other risk prioritization factors. A specific example of a risk factor importance input mechanism 80, is shown and described in relation to FIGS. 3-5, infra. The risk prioritization factors are associated with the specific line-of-business, business unit or the like under which the specific processes that are being prioritized are included. In specific embodiments of the invention, in order to achieve independence in the risk-based process prioritization methodology, the importance indicators 22 are received from one or more second level entities within the business, such as a risk-owner/risk management participants or the like.

In one specific embodiment of the invention, the risk prioritization factors 24 may include two or more of technology risk, financial risk, regulatory risk, external risk, operational risk, strategy risk, associate/employee risk and customer risk. In addition to these standard risk categories, embodiments of the invention may provide for creation/definition of additional risk prioritization factors 24 at the discretion of the risk-owner/risk management entity. In assessing the comparative importance of the risk prioritization factors 24 to one another, each risk prioritization factor 24 may be configured to include further attributes, which serve to define the risk prioritization factor 24 for the benefit of the entity making the importance indicator 22 assessments. In one specific embodiment of the invention, the importance indicators 22 include “much more important”, which indicates that one risk prioritization factor 24 is much more important than the risk prioritization factor 24 it is being compared to; “more important”, which indicates that one risk prioritization factor 24 is more important than the risk prioritization factor it is being compared to; “equally important”, which indicates that the risk prioritization factor is equally important to the risk prioritization factor 24 it is being compared to; “less important”, which indicates that one risk prioritization factor 24 is less important than the risk prioritization factor it is being compared to; and “much less important”, which indicates that one risk prioritization factor 24 is much less important than the risk prioritization factor 24 it is being compared to.

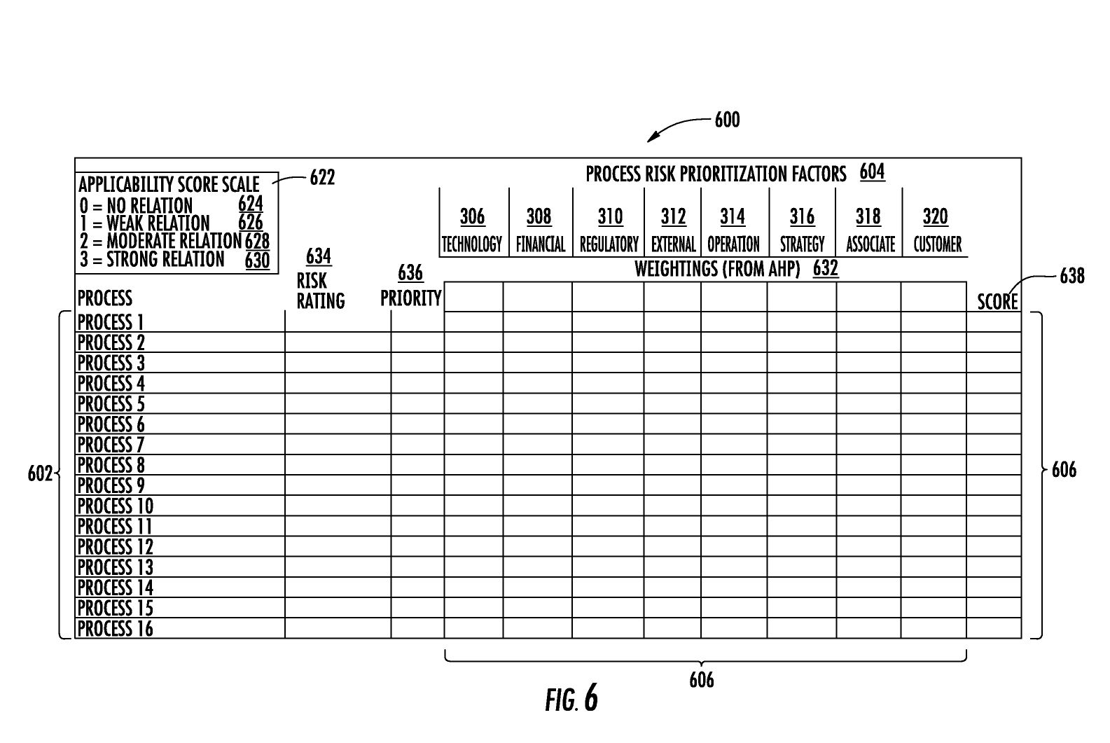

In further specific embodiments of the invention, the risk prioritization application 18 includes process-to-risk applicability input mechanism 90, which may be a spreadsheet-based grid, matrix or the like suitable for receiving applicability scores 32 that each indicate the relative importance between each of the plurality of risk prioritization factors 24 and a corresponding one of the other risk prioritization factors. A specific example of a process-to-risk applicability input mechanism 90 is shown and described in relation to FIGS. 6-8, infra. In specific embodiments of the invention, in order to achieve independence in the risk-based process prioritization methodology, the applicability scores 32 are received from one or more first level entities within the business, such as one or more line-of-business participants, business unit entity or the like.

In further specific embodiments of the invention, the applicability score 32 is a configured to be a integer between zero and a predetermined maximum integer, where zero represents no relation between the process and the risk prioritization factor and the maximum integer represents a strong relation between the process and the risk prioritization factor. In specific embodiment of the invention, the applicability score is configured to an integer between zero and three, where “zero” represents no relation between the process and the risk prioritization factor; “one” represents a weak relation between the process and the risk prioritization factor; “two” represents a moderate relation no relation between the process and the risk prioritization factor; and “three” represents a strong relation between the process and the risk prioritization factor.

As previously noted, the process risk prioritization routine further includes risk weighting routine 20 that is configured to determine a risk weight 26 for each of the plurality of risk prioritization factors 24 based on the importance indicators 22. Additionally, as previously noted, in specific embodiments of the invention the risk weighting routine 20 is an Analytical Hierarchy Process (AHP) algorithm. In specific embodiments of the invention, the risk weight 26 is represented in terms of a percentage such that the cumulative total of all the percentages for all the risk prioritization factors 24 equals one-hundred percent (100%).

In certain embodiments of the invention the risk factor relative importance input mechanism 80 may include a series of questions (not shown in FIG. 2) associated with each of the risk prioritization factors 24 such that answers provided by the one or more risk-owner participants to the questions are implemented to derive importance indicators 22 and/or to determine, at least in part, the risk score 26.

In addition, as previous noted, process risk prioritization application 18 includes risk score routine 30 that is configured to determine a risk score 36 for each of the processes based on the risk weighting 26 and applicability scores 32 for each risk prioritization factor 24. In one specific embodiment of the invention, the risk score 36 is calculated by multiplying the applicability score 36 by the risk weighting 26 for each risk prioritization factor, summing the products of the multiplication and dividing the sum by the highest integer value configured to be implemented as an applicability score 32. In such embodiments, the resulting risk score 36 is a provided as a percentage between zero and one-hundred. In certain embodiments of the invention the risk process-to-risk applicability input mechanism 90 may include a series of questions (not shown in FIG. 2) associated with each of the processes 34 such that answers provided by one or more line-of-business participants to the questions are used by the risk scoring routine 30 to determine, at least in part, the risk score 36.

Additionally, the risk score routine 30 may be configured to determine a risk rating category 38 for each process 34 based on the risk score 36. For example, in one embodiment of the invention, three different risk rating categories 38 may exist; (1) high risk, (2) medium risk and (3) low risk. In specific embodiments of the invention, ranges of risk scores 36 define the risk rating category 38 to be applied to the process 34. For example, risk scores between zero percent and thirty-three percent may define a low risk category, risk scores between thirty-four percent and sixty-six percent may define a medium risk category and risk scores between sixty-seven percent and one-hundred percent may define a high risk category.

In addition, process risk prioritization application 18 includes risk priority routine 40 that is configured to determine risk priority 42 for each of the plurality of predefined processes 34 based on the risk score 36. In this regard, the risk priority 42 provides for a numerical listing of the processes 34 in which the order of the listing coincides with the order of the risk scores 36. In specific embodiments, only those processes 34 which have a risk score 36 greater than zero percentage are included in the priority listing. For example, if twenty processes 34 are being considered and sixteen of the processes 34 result in risk scores 34 greater than zero percentage, the resulting priority listing will include values between one and sixteen, with one being the highest in terms of risk priority (i.e., the most riskiest process) and sixteen being the lowest in terms of risk priority (i.e., the least riskiest process).

Further the apparatus 10 may include a risk control system (not shown in FIG. 2) that is configured monitor associated risks and create necessary controls. In addition, the risk control system may be configured to assess the strength of the controls and analyze whether the strength of the control is commensurate with the risk at a granular and/or organizational level.

Referring to FIG. 3 an example is shown of a data input/output mechanism 300, including a risk factor relative importance input mechanism (80 of FIG. 2), in accordance with an embodiment of the present invention. The data input/output mechanism 300 may be a spreadsheet-based input mechanism, such as an Excel® spreadsheet, distributed by the Microsoft Corporation of Redmond, Wash. or the like. The data input/output mechanism 300 is in the form of a two-dimensional grid/matrix, in which the risk prioritization factors 306-320 are listed vertically along the y-axis 302 and the same risk prioritization factors 306-320 are listed horizontally along the x-axis 304. The risk prioritization factors in the illustrated embodiment of FIG. 3 include technology 306, financial 308, regulatory 310, external 312, operational 314, strategy 316, associate and customer 320. However, it should be noted that the risk prioritization factors shown are by way of example only and other embodiments of the invention may include more or less risk prioritization factors based on the needs of the business implementing the risk-based process prioritization procedure of the present invention. FIG. 3 additionally includes importance indicator key 322 that includes the various importance indicators 324-332. In the illustrated example, the importance indicators include, “Much More Important (MMI)” 324; “More Important (MI)” 326; “Equally Important (EQUAL)” 328; “Less Important (LI)” 330; and “Much More Important (MLI)” 332. However, it should be noted that the importance indicators 324-332 shown are by way of example only and other embodiments of the invention may include more or less importance indicators based on the needs of the business implementing the risk-based process prioritization procedure of the present invention.

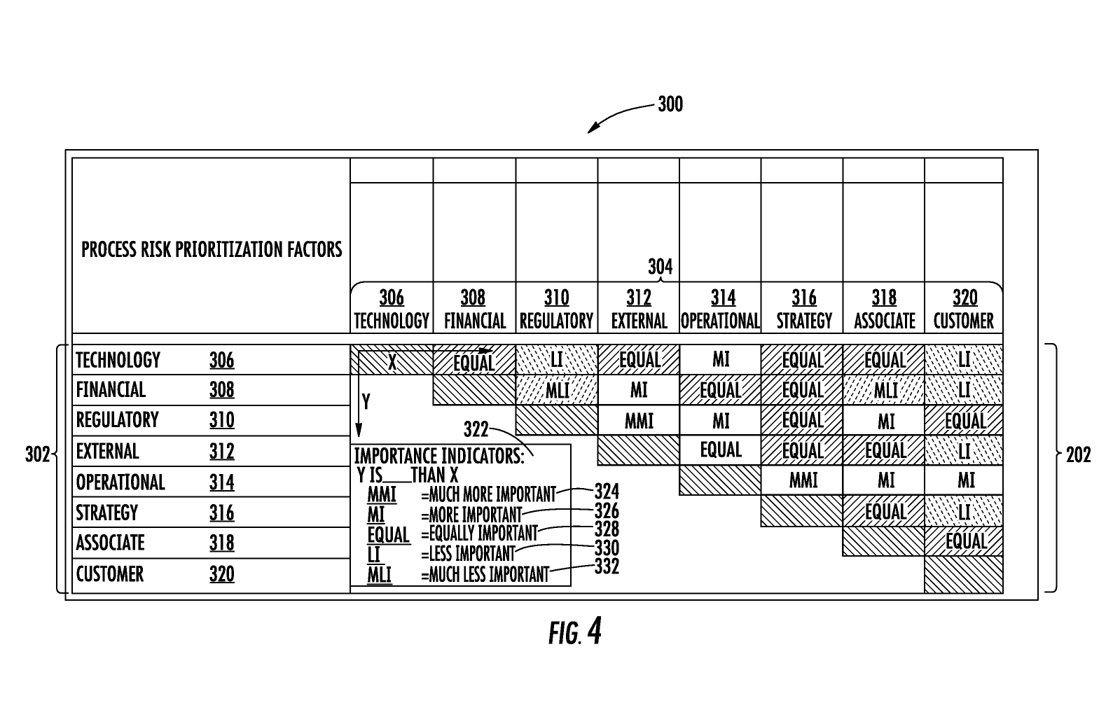

FIG. 4 is an example of a data input/output mechanism 300, including a risk factor relative importance input mechanism (80 of FIG. 2), in which importance indicators 324-332 have been received into the grid/matrix 402. As previously noted, the importance indicators 324-332 are received from one or more second level entities within the business, such as a risk owner/risk management entity or the like. The importance indicators 324-332 represent the relative importance of the risk prioritization factors to one another for a particular business unit, line-of-business, business channel or the like. Based on the importance indicator key 322, which indicates that the Y-axis risk prioritization factor is “______” than the x-axis risk prioritization factor, where the “______” is filled in with the assigned importance indicator 324-332. Thus, for example, reading the received importance indicators 324-332 in grid/matrix 402, beginning at the top, left-hand corner, technology is equally important to finance; technology is less important than regulatory; technology is equally important to external; technology is more important than operational; etc.

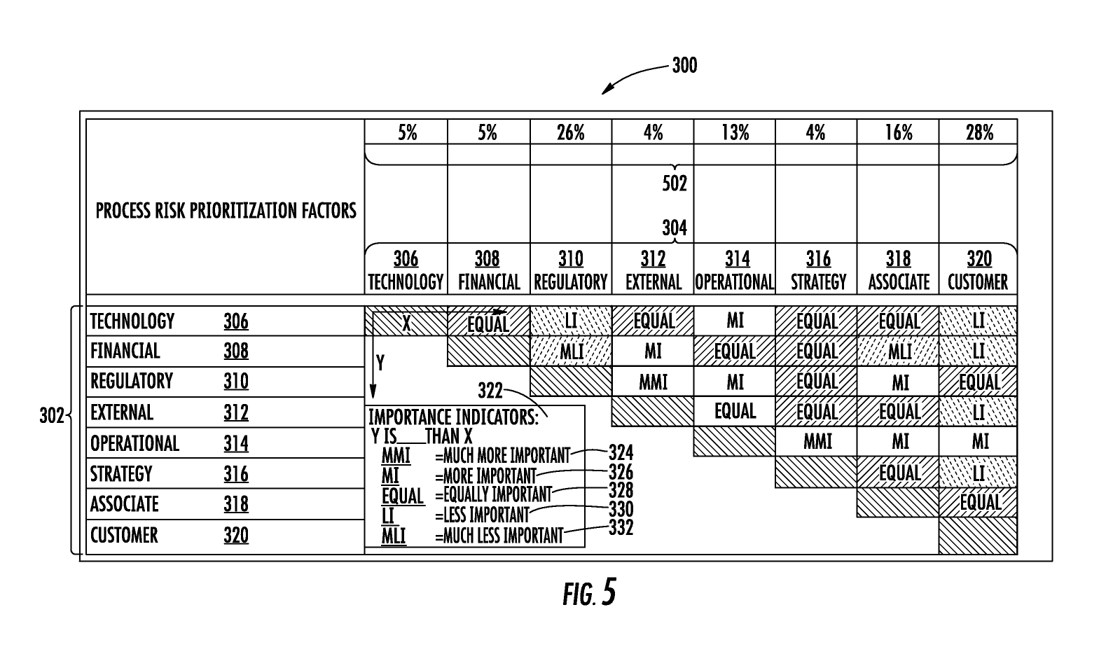

FIG. 5 is an example of a data input/output mechanism 300, including a risk factor relative importance input mechanism (80 of FIG. 2), in which the risk weighting routine (20 of FIGS. 1 and 2) has been executed to determine a risk weighting 502 for each of the risk prioritization factors 306-320 based on the importance indicators 324-332 received into grid 402. In the illustrated example an Analytical Hierarchy Process algorithm has been implemented to determine risk weightings 502. In the illustrated example of FIG. 5, technology 306 has been determined to have a risk weight of five percent; financial 308 has been determined to have a risk weight of five percent; regulatory 310 has been determined to have a risk weight of twenty-six percent; external 312 has been determined to have a risk weight of four percent; operational 314 has been determined to have a risk weight of thirteen percent; strategy 316 has been determined to have a risk weight of four percent; associate/employee 318 has been determined to have a risk weight of sixteen percent and customer 320 has been determined to have a risk weight of twenty-eight percent.

Referring to FIG. 6 an example is shown of a data input/output mechanism 600, including a process-to-risk applicability input mechanism (90 of FIG. 2), in accordance with an embodiment of the present invention. The data input/output mechanism 600 may be a spreadsheet-based input mechanism, such as an Excel® spreadsheet, distributed by the Microsoft Corporation of Redmond, Wash. or the like. The data input/output mechanism 600 is in the form of a two-dimensional grid/matrix 606, in which the processes 602 are listed vertically along the y-axis and the risk prioritization factors 604 are listed horizontally along the x-axis. The risk prioritization factors in the illustrated embodiment of FIG. 6 are the same as those shown and described in FIGS. 3-5, and include technology 306, financial 308, regulatory 310, external 312, operational 314, strategy 316, associate and customer 320. FIG. 6 additionally includes applicability score key 622 that includes the various applicability scores 624-630. In the illustrated example, the applicability include, “zero” 624, which indicates no relation between the process and the risk prioritization factor; “one” 626, which indicates a weak relation between the process and the risk prioritization factor “two” 628, which indicates a moderate relation between the process and the risk prioritization factor and “three” 630, which indicates a strong relation between the process and the risk prioritization factor. It should be noted that the applicability scores 624-630 shown are by way of example only and other embodiments of the invention may include more or less applicability scores based on the needs of the business implementing the risk-based process prioritization procedure of the present invention.

Additionally, the data input/output mechanism 600 includes risk rating column 634 that list an output of the risk rating categories for each process, priority column 636 that lists an output of the priority for each process and risk score column 638 that lists an output of the risk scores. In addition, the data input/output mechanism 600 includes risk weighting row 632 that list an output of risk weights. In specific embodiments of the invention, the data input/output mechanism 600 imports the risk weights from the data input/output mechanism shown and described in FIGS. 3-5.

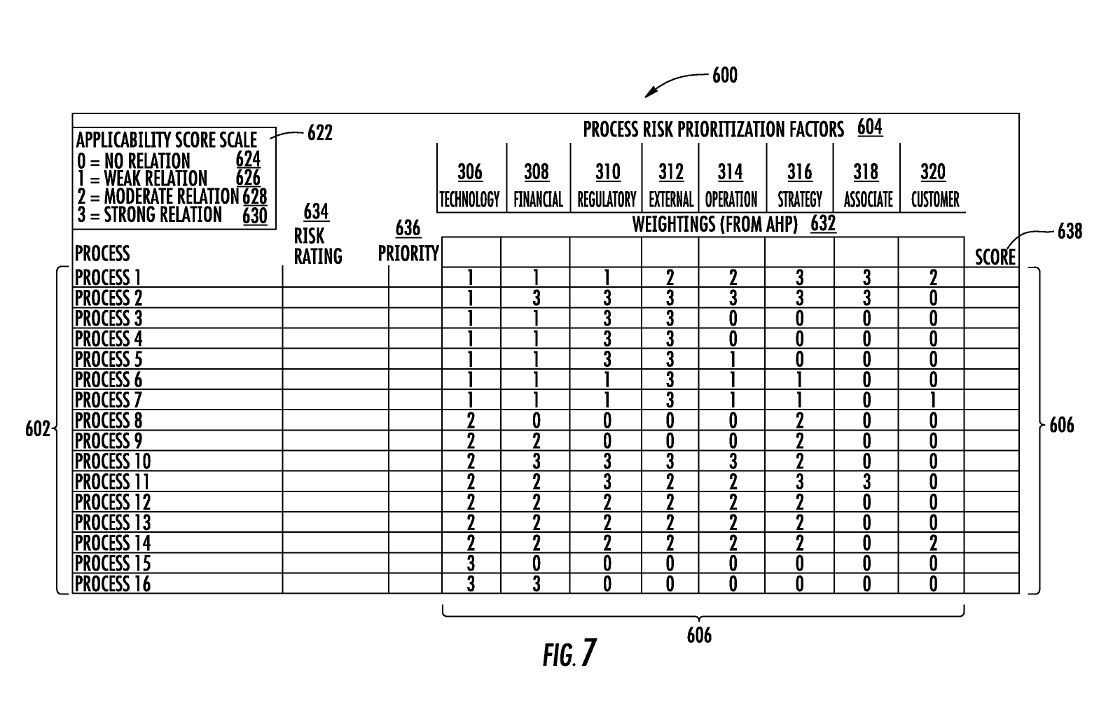

FIG. 7 is an example of a data input/output mechanism 600, including a process-to-risk applicability input mechanism (90 of FIG. 2), in which applicability scores 624-630 have been received into the grid/matrix 606. As previously noted, the applicability scores 624-630 are received from one or more first level entities within the business, such as a line-of-business, business unit entity or the like. The applicability scores 624-630 represent the degree of relationship between a process and a risk prioritization factor. In the illustrated example of FIG. 7, reading the received applicability scores in grid/matrix 606, beginning at the top, left-hand corner, the applicability score for Process 1 and Technology is one; the applicability score for Process 1 and Financial is one; the applicability score for Process 1 and Regulatory is 2; the applicability score for Process 1 and External is two; etc.

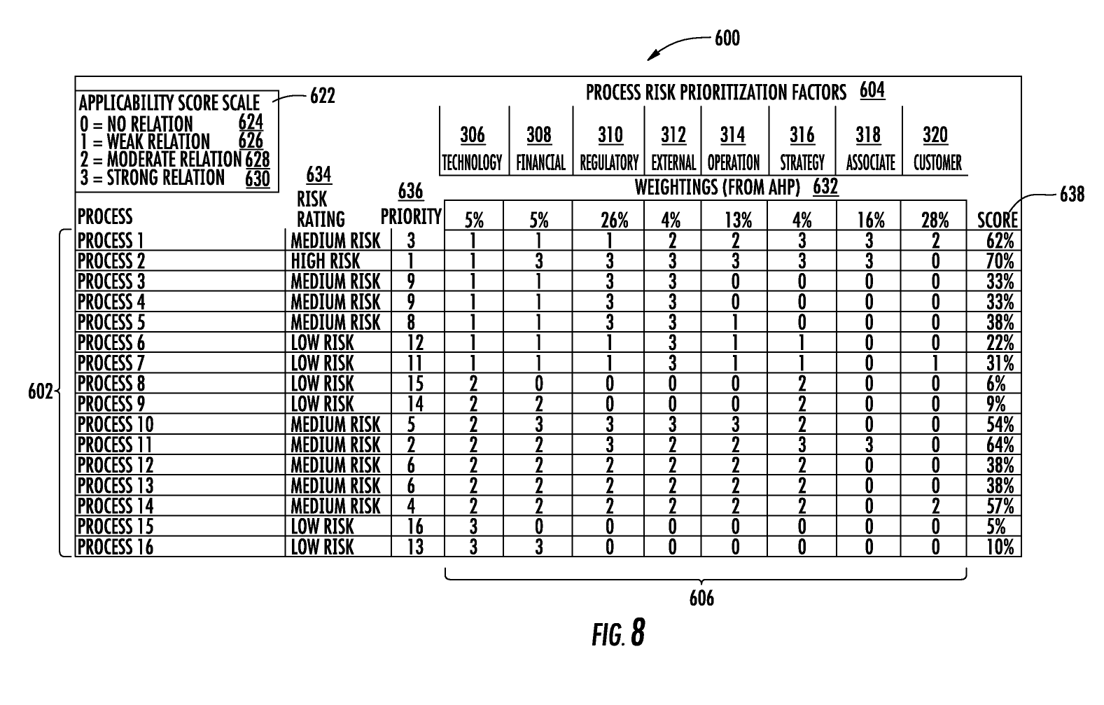

FIG. 8 is an example of a data input/output mechanism 600, including a process-to-risk applicability input mechanism (90 of FIG. 2), in which the risk score routine and risk priority routine (30 and 40 of FIGS. 1 and 2) have been executed to determine a risk score and a risk priority for each of the processes 602 based on the applicability scores 624-630 received into grid 606 and the risk weightings 632 imported from data input/output mechanism 300 of FIGS. 3-5. In the illustrated example, the risk scores, which are shown in risk score column 638 are determined by multiplying the applicability score for a specified risk prioritization process by the associated risk weighting, summing all of the multiplication products and dividing by the highest valued applicability score (in this example, the highest valued applicability score is three. Thus, in the illustrated example of FIG. 8, the risk score for Process 1 is calculated as (0.05×1)+(0.05×1)+(0.20×1)+(0.04×2)+(0.13×2)+(0.04×3)+(0.16×3)+(0.28×2)/3=62 percent.

The risk priority, which is shown in risk priority column 636, is determined by the rank of the risk scores. In the illustrated example, since Process 2 has the highest risk score, i.e., 70 percent, it is given a risk priority of one, since Process 11 has the second highest risk score, i.e., 64 percent, it is given a risk priority of two, since Process 1 has the third highest risk score, i.e., 62 percent, it is given a risk priority of three and so on.

The risk rating category, which is shown in risk rating column 634, is determined by comparing the risk score to predetermined risk categories. In the illustrated example of FIG. 8, risk scores of zero to thirty three percent fall into the low risk category, risk scores of thirty-four to sixty-six percent fall into the medium risk category and risk scores of sixty-seven to one-hundred percent fall into the high risk category. Thus, Processes 6, 7, 8, 9, 15 and 16 are determined to be low risk category, Processes 1, 3, 4, 5, 10, 11, 12, 13, 14 are determined to be medium risk category and Process 2 is determined to be high risk category.

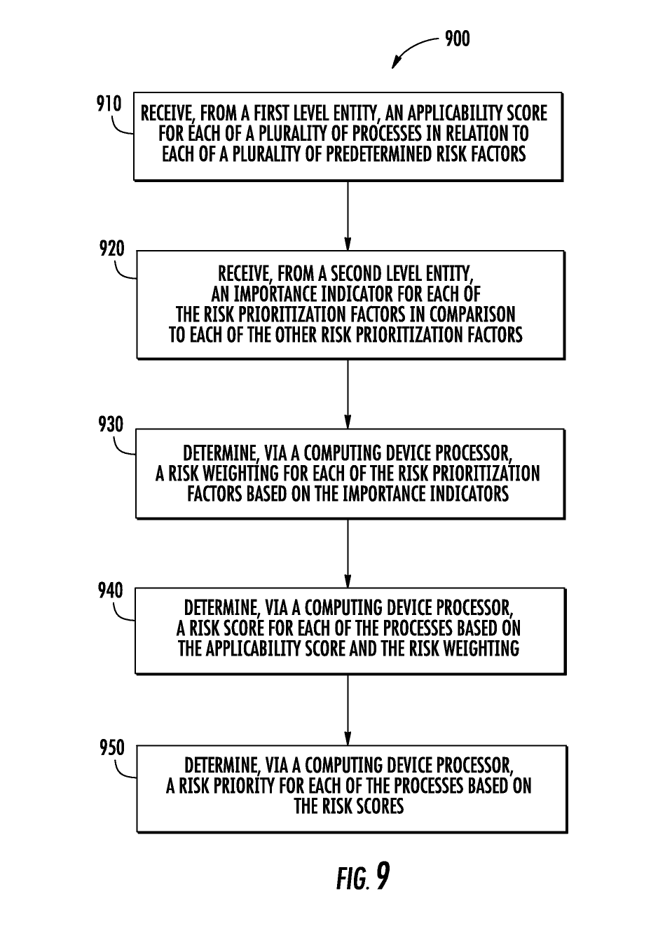

Turning the reader's attention to FIG. 9 a flow diagram is depicted of a method 900 for process prioritization based on risk, in accordance with embodiments of the present invention. At Event 910, an applicability score for each of a plurality of processes in relation to each of a plurality of predetermined risk prioritization factors is received from one or more first level entities. As previously noted for sake of this disclosure, the term process includes sub-processes, initiatives, projects or the like. The applicability score may be an integer value where zero represents no relationship between the process and risk prioritization factor and a highest configured integer represents the strongest relationship between a process and a risk prioritization factor. The first level entity may be any entity within the business responsible for profits and losses, including, but not limited to, a line-of-business, a business unit or the like. The risk prioritization factors may include, but are not limited to, two or more of technology, financial, regulatory, external, operational, strategy, associate/employee and customer.

At Event 920, an importance indicator for each of the risk prioritization factors in comparison to each of the other risk prioritization factors is received from one or more second level entities. The importance indicator indicated the level of relation between two risk prioritization factors. The second level entity may be any entity within the business responsible for risk control, including, but not limited to, a risk owner, risk management or the like. It should be noted that due to the independent processing nature of Events 910 and 920 these events can be conducted in parallel or in series and in any order.

At Event 930, a risk weighting is determined for each of the risk prioritization factors based on the importance indicators. In specific embodiments of the invention Analytical Hierarchy Process (AHP) is implemented to determine the risk weightings.

At Event 940, risk scores are determined for each of the processes based on the applicability score and the risk weighting. In specific embodiments of the invention, the risk score is determined by multiplying the risk weighting by the applicability score for each risk prioritization factor, summing the multiplied products and dividing the sum by the highest value of the applicability scores. At Event 950, risk priority is determined based on the risk scores. The risk priority provided a ranking of the processes in terms of risk, where a ranking of one may indicate the highest level of risk amongst the processes. Additionally, the method may include determining a risk rating category for each process based on the risk score. The risk rating category may be determined by comparing the risk scores to predetermined risk ranges which equate to risk categories.

Thus, present embodiments herein disclosed provide for prioritizing processes in terms of risk. Specifically, present embodiments provide assessment of process applicability to risk factors and assessment of the relative importance of the risk factors, wherein the assessments are conducted independently by separate corporate entities, for example line-of-business entity and risk owner entity. The two independent assessments are subsequently used to determine a process risk score that allows for the processes to be prioritized. The independent nature of the assessments provides for a highly objective, fact-based means of prioritizing processes based on risk.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other updates, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

1. An apparatus for prioritizing processes based on risk, the apparatus comprising:
a computing device including a memory and at least one processor; and
a process risk prioritization application stored in the memory, executable by the processor, configured to determine risk priority for a plurality of processes and including:
a risk weighting routine configured to receive, from one or more second level entities, an importance indicator for each of a plurality of a risk prioritization factors in comparison to each of the other risk prioritization factors and determine a risk weighting for each of the risk prioritization factors based on the importance indicators;
a risk score routine configured to receive, from one or more first level entities, an applicability score for each of a plurality of predefined processes in relation to each of the predetermined risk prioritization factors and determine a risk score for each of the processes based on the applicability score and the risk weighting; and
a risk priority routine configured to determine a risk priority for each of the processes based on the risk scores.

2. The apparatus of claim 1, wherein the risk score routine is further configured to receive, from one or more line-of-business participants, the applicability score for each of the plurality of processes in relation to each of the predetermined risk prioritization factors.

3. The apparatus of claim 1, wherein the risk weighting routine is further configured to receive, from one or more risk owner participants, the importance indicator for each of the risk prioritization factors in comparison to each of the other risk prioritization factors.

4. The apparatus of claim 2, wherein the process risk prioritization application further comprises a process-to-risk applicability input mechanism configured to receive, from the line-of-business entity, the applicability score for each of the plurality of processes in relation to each of the predetermined risk prioritization factors.

5. The apparatus of claim 3, further wherein the process risk prioritization application further comprises a risk-factor importance input mechanism configured to, receive, from one or more risk owner participants, the importance indicator for each of the risk prioritization factors in comparison to each of the other risk prioritization factors.

6. The apparatus of claim 1, wherein the risk weighting routine is further configured to implement Analytical Hierarchy Process (AHP) to determine the risk weightings.

7. The apparatus of claim 1, wherein the risk weighting routine is further configured to receive the importance indicator, wherein the importance indicator is one of (1) much more important, (2) more important, (3) equally important, (4) less important or (5) much less important.

8. The apparatus of claim 1, wherein the risk score routine is further configured to receive the applicability weighting factor for each of the plurality of processes in relation to each of the plurality of risk prioritization factors, wherein the plurality of risk prioritization factors include two or more of technology risk, financial risk, regulatory risk, external risk, operational risk, strategy risk, associate risk and customer risk.

9. The apparatus of claim 1 wherein the risk score routine is further configured to determine a plurality of products by multiplying, for each risk prioritization factor, the applicability score by the risk weighting and summing the products to result in the risk score.

10. The apparatus of claim 1, wherein the risk score routine is further configured to determine, for each of the plurality of processes, a risk rating category based on the risk score.

11. A method for prioritizing processes based on risk, the method comprising:
receiving, at a first entity level, an applicability score for each of a plurality of processes in relation to each of a plurality of predetermined risk prioritization factors;
receiving, at a second entity level, an importance indicator for each of the risk prioritization factors in comparison to each of the other risk prioritization factors;
determining, via a computing device processor, a risk weighting for each of the risk prioritization factors based on the importance indicators;
determining, via a computing device processor, a risk score for each of the processes based on the applicability score and the risk weighting; and
determining, via a computing device processor, a risk priority for the processes based on the risk scores.

12. The method of claim 11, wherein receiving the applicability score further comprises receiving, from one or more line-of-business participants, the applicability score for each of the plurality of processes in relation to each of the plurality of predetermined risk prioritization factors.

13. The method of claim 11, wherein receiving the importance indicator further comprises receiving, from a risk-owner level, the importance indicator for each of the risk prioritization factors in comparison to each of the other prioritization factors.

14. The method of claim 11, wherein determining a risk weighting further comprises determining, via the computing device processor, the risk weighting by implementing Analytical Hierarchy Process (AHP).

15. The method of claim 11, wherein receiving the importance indicator further comprises receiving the importance indicator, wherein the importance indicator is one of (1) much more important, (2) more important, (3) equally important, (4) less important and (5) much less important.

16. The method of claim 11, wherein receiving an applicability score further comprises receiving the applicability score for each of the plurality of processes in relation to each of the plurality of risk prioritization factors, wherein the plurality of risk prioritization factors include two or more of technology risk, financial risk, regulatory risk, external risk, operational risk, strategy risk, associate risk and customer risk.

17. The method of claim 11, wherein determining the risk score further comprises multiplying, via a computing device processor, for each risk prioritization factor, the applicability score by the risk weighting to result in a product and summing, via the computing device processor, the products to result in the risk score.

18. The method of claim 11, further comprising determining, via a computing device processor, for each of the plurality of processes, a risk rating category based on the risk score.

19. The method of claim 11, further comprising applying the priority for each of the plurality of processes to a design of process controls to insure that process controls are commiserate with risk.

20. A computer program product comprising:
a non-transitory computer-readable medium comprising:
a first set of codes for causing a computer to receive a plurality of processes and an applicability score for each of the plurality of processes in relation to each of a plurality of predetermined risk prioritization factors;
a second set of codes for causing a computer to receive an importance indicator for each of the risk prioritization factors in comparison to each of the other risk prioritization factors;
a third set of codes for causing a computer to determine a risk weighting for each of the risk prioritization factors based on the importance indicators;
a fourth set of codes for causing a computer to determine a risk score for each of the processes based on the applicability score and the risk weighting; and
a fifth set of codes for causing a computer to determine a risk priority for the processes based on the risk scores.

21. The computer program product of claim 20, wherein the first set of codes is further configured to cause the computer to receive, from one or more line-of-business participants, a plurality of processes and an applicability score for each of the plurality of processes in relation to each of a plurality of predetermined risk prioritization factors

22. The computer program product of claim 20, wherein the second set of codes is further configured to cause the computer to receive, from one or more risk owner participants, the importance indicator for each of the risk prioritization factors in comparison to each of the other prioritization factors.

23. The computer program product of claim 20, wherein the third set of codes is further configured to cause the computer to determine the risk weighting by implementing Analytical Hierarchy Process (AHP).

24. The computer program product of claim 20, wherein the second set of codes is further configured to cause the computer to receive the importance indicator, wherein the importance indicator is one of (1) much more important, (2) more important, (3) equally important, (4) less important and (5) much less important.

25. The computer program product of claim 20, wherein the first set of codes is further configured to receive the applicability score for each of the plurality of processes in relation to each of the plurality of risk prioritization factors, wherein the plurality of risk prioritization factors include two or more of technology risk, financial risk, regulatory risk, external risk, operational risk, strategy risk, associate risk and customer risk.

26. The computer program product of claim 20, wherein the fourth set of codes is further configured to cause the computer to multiply, for each risk prioritization factor, the applicability score by the risk weighting to result in a product and sum the products to result in the risk score.

27. The computer program product of claim 20, further comprising a sixth set of codes for causing a computer to determine, for each of the plurality of processes, a risk rating category based on the risk score.
